(19) United States
(12) Patent Application Publication
(10) Pub. No.: US 2014/0327771 A1
(43) Pub. Date: Nov. 6, 2014

(54) SYSTEM, METHOD, AND COMPUTER PROGRAM PRODUCT FOR DISPLAYING A SCENE AS A LIGHT FIELD

(71) Applicant: NVIDIA CORPORATION, Santa Clara, CA (US)

(72) Inventors: Chris A. Malachowsky, Los Altos, CA (US); David Patrick Luebke, Charlottesville, VA (US); Douglas Robert Lanman, Sunnyvale, CA (US)

(73) Assignee: NVIDIA Corporation, Santa Clara, CA (US)

(21) Appl. No.: 13/875,238

(22) Filed: May 1, 2013

(51) Int. Cl. H04N 7/18

(52) U.S. Cl. CPC H04N 7/18
USPC 348/148

(57) ABSTRACT

A system, method, and computer program product that displays a light field to simulate a reflected scene. The method includes the operations of receiving a scene representing an exterior viewpoint relative to an observer positioned in a vehicle, determining a pre-filtered image that simulates a reflection of the scene, where the pre-filtered image represents a light field and corresponds to a target image that simulates a mirror. The pre-filtered image is displayed as the light field to produce the target image.

### FIELD

1. Field of the Invention

The present invention relates to image display, and more specifically to displaying a scene as a light field.

2. Background of the Invention

Recently, digital displays have been adopted to replace portions of the instrument console in automobiles. When viewed by a farsighted driver, the instrument console provided by the digital display may appear blurry in the absence of vision correction. In contrast, the view through the windshield of the automobile is in focus for a farsighted driver. Therefore, wearing corrective eyewear to view a clear image of the digital display may interfere with perceiving a clear image of the scene through the windshield.

Similarly, when a rear-view mirror in an automobile is replaced with a digital display, the image on the digital display may appear blurry to a farsighted driver. When a farsighted driver views a scene in an actual rear-view mirror, the driver sees the reflected light field of far-away objects and those objects appear in focus (i.e., just as if the driver were looking through a window at the far-away objects). In contrast, when the rear-view mirror is replaced with a display showing the far-away objects captured by a camera, the farsighted driver is unable to focus on the image of the far-away object shown on the digital display without vision correcting lenses. Thus, there is a need for addressing this issue and/or other issues associated with the prior art.

### SUMMARY

A system, method, and computer program product that displays a light field to simulate a reflected scene. A scene representing an exterior viewpoint relative to an observer positioned in a vehicle is received and a pre-filtered image that simulates a reflection of the scene is determined, where the pre-filtered image represents a light field and corresponds to a target image that simulates a mirror. The pre-filtered image is displayed as the light field to produce the target image.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1A depicts a flowchart of an exemplary technique for processing a scene for display using a light field display, according to an embodiment of the present invention.

FIG. 1B depicts another flowchart of an exemplary technique for processing a scene for display using a light field display, according to another embodiment of the present invention.

FIG. 2A illustrates an eye of an observer and a corresponding accommodation range.

FIGS. 2B and 2C depict perceived images at different viewing distances of an observer.

FIG. 3A illustrates a ray of light originating from a plane of focus, according to embodiments of the present invention.

FIG. 3B illustrates a side view of a near-eye microlens array display, according to embodiments of the present invention.

FIG. 3C illustrates a side view of a multiple microlens array, according to embodiments of the present invention.

FIG. 4 illustrates a ray of light that is part of a light field, according to embodiments of the present invention.

FIG. 5 illustrates a side view of a magnified view of the near-eye microlens array display, according to embodiments of the present invention.

FIG. 6A depicts another flowchart of an exemplary technique for processing a scene for display using a light field display, according to an embodiment of the present invention.

FIG. 6B depicts yet another flowchart of an exemplary technique for processing a scene for display using a light field display, according to an embodiment of the present invention.

FIG. 7 is an exemplary computer system, in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

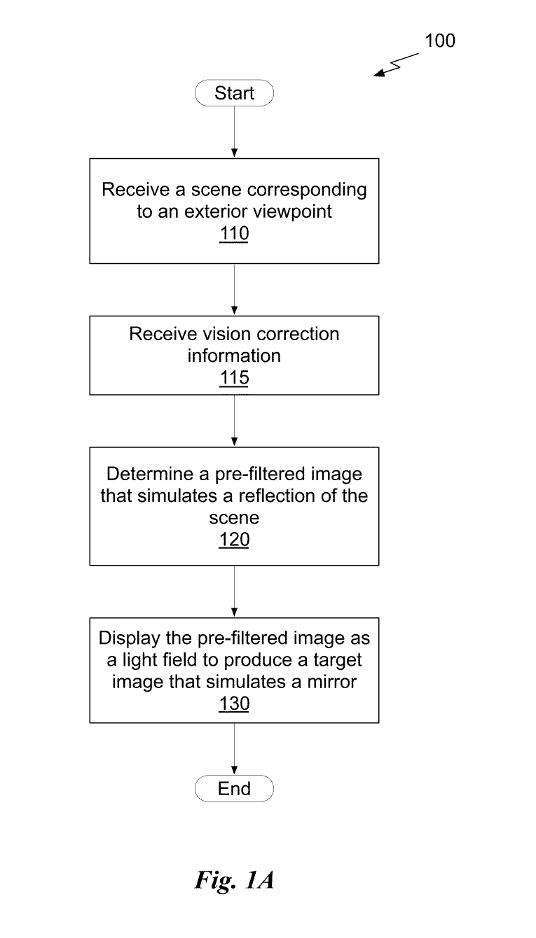

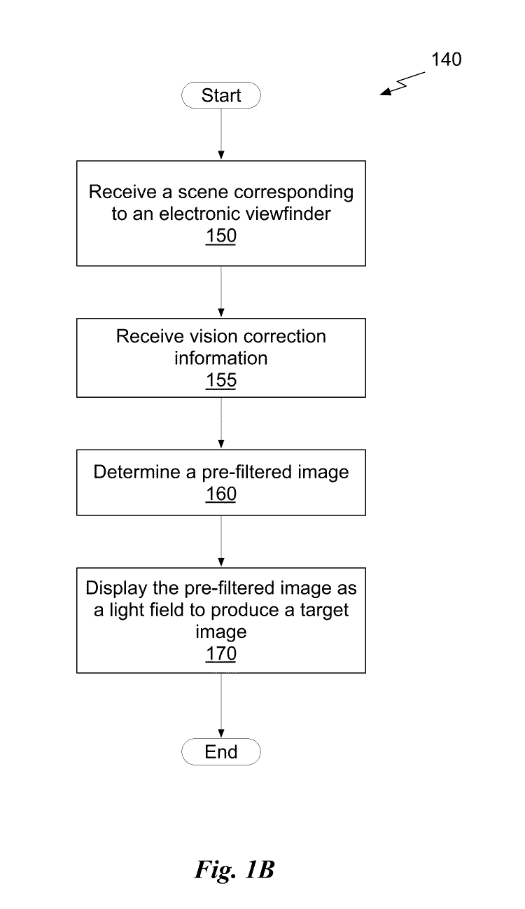

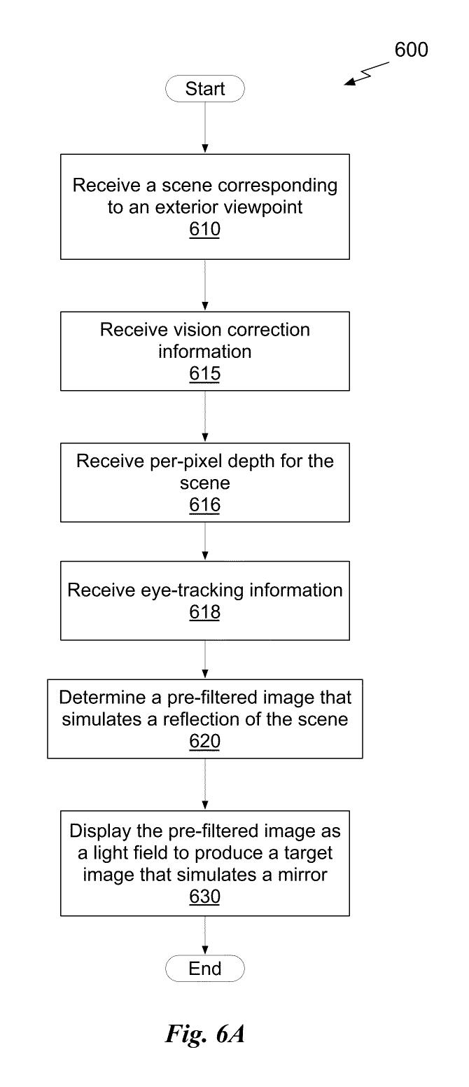

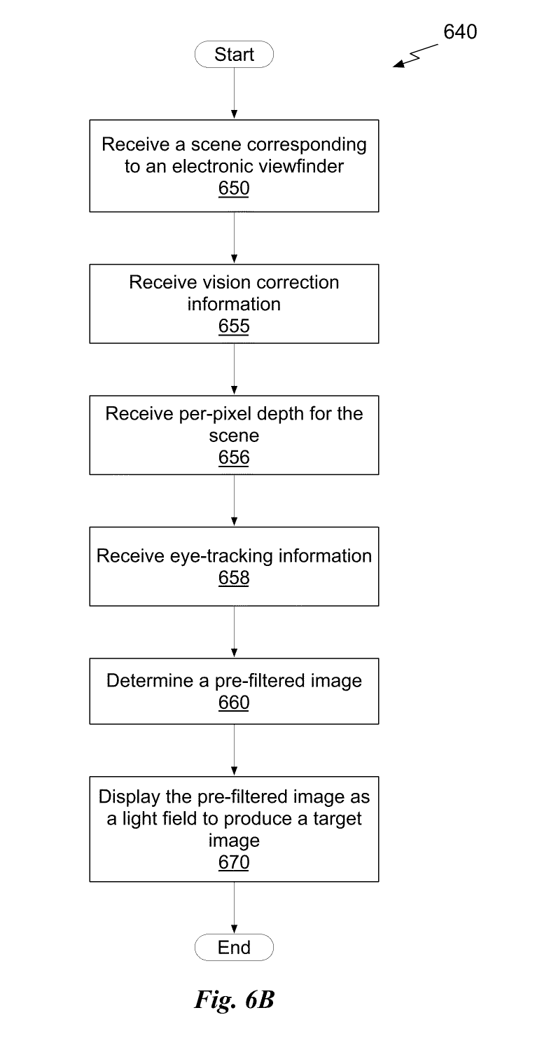

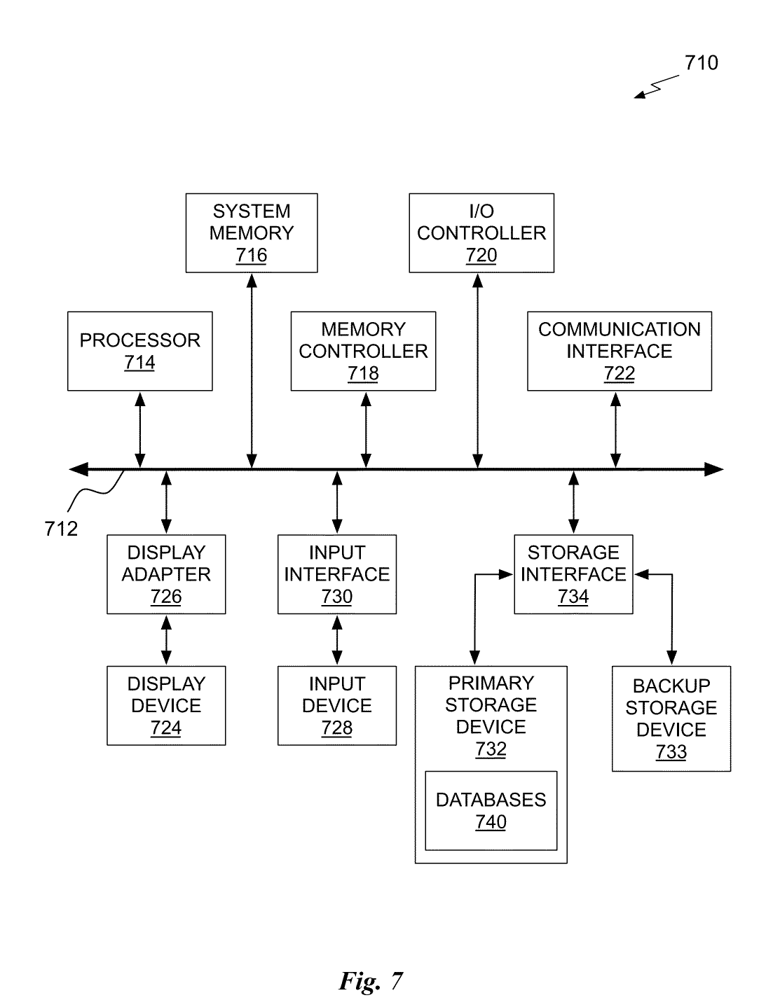

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “displaying,” “generating,” “producing,” “calculating,” “determining,” “radiating,” “emitting,” “attenuating,” “modulating,” “transmitting,” “receiving,” or the like, refer to actions and processes (e.g., flowcharts 100, 140, 600, and 640 of FIGS. 1A, 1B, 6A, and 6B) of a computer system or similar electronic computing device or processor (e.g., system 810 of FIG. 7). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1A depicts a flowchart 100 of an exemplary technique for processing a scene for display using a light field display, according to an embodiment of the present invention. At operation 110, a scene corresponding to an exterior viewpoint relative to an observer is received. For example, an observer may be positioned in a vehicle such as an automobile or an airplane and the exterior viewpoint may be a scene as viewed from the exterior of the vehicle. The scene may be captured via a camera. At operation 115, vision correction information is received. An example of vision correction is an optical prescription for the observer.

At operation 120, a pre-filtered image to be displayed is determined, where the pre-filtered image represents a light field and corresponds to a target image. For example, a computer system may determine a pre-filtered image that simulates a reflection of the scene. The pre-filtered image may be determined based on the optical prescription to produce an image that simulates a reflection of the scene and that may be viewed by the observer without prescription eyewear. The pre-filtered image may be blurry when viewed by itself but in focus when viewed through a filter or light field generating element. Alternatively, the pre-filtered image may be determined to allow the observer to view the pre-filtered image while wearing prescription or non-prescription eyewear. Furthermore, a non-linear distortion may be applied to generate the pre-filtered image to simulate a distorted reflection of the scene.

At operation 130, the light field is produced after the pre-filtered image travels through a light field generating element, wherein the light field is operable to simulate a light field corresponding to a target image that simulates a mirror. In one embodiment, the light field may be generated by a microlens array display. When viewed by a farsighted observer, the target image appears focused, allowing the observer to clearly see through the windshield while also viewing the target image that simulates a rear-view, side-view, or other mirror reflecting an exterior viewpoint relative to the vehicle. When an actual mirror reflecting a scene that is outside of a vehicle is viewed by a farsighted observer, the reflected scene appears focused because the distance between the observer and the reflected scene is the sum of the distance between the observer and the mirror and the distance between the scene and the mirror. In contrast, when the reflected scene is displayed to simulate a mirror, the scene may appear blurry because the reflected scene image is positioned at distance from the observer within which the observer cannot focus. Employing a light field to display the pre-filtered image that is generated based on the vision correction information causes the target image to appear in focus to a farsighted observer without requiring corrective eyewear. A light field display supports the control of the direction of individual rays of light. For example, the radiance of a ray of light for each pixel may be modulated as a function of position across the display, as well as the direction in which the ray of light leaves the display. Therefore, when the pre-filtered image is displayed by a light field display, the light field display may adjust individual rays of light based on the vision correction information associated with the observer to produce the target image.

FIG. 1B depicts another flowchart 140 of an exemplary technique for processing a scene for display using a light field display, according to another embodiment of the present invention. At operation 150, a scene corresponding to an electronic viewfinder is received. For example, an observer may be operating an image capture device, e.g., camera, held at arm's length to capture a scene viewed through a lens. An electronic viewfinder displays a scene captured from the point-of-view through a lens of the image capture device. The electronic viewfinder may be configured to display a preview of an image that can be captured by the user. At operation 155, vision correction information is received. An example of vision correction information is an optical prescription for the observer.

At operation 160, a pre-filtered image to be displayed is determined, where the pre-filtered image simulates the scene and corresponds to a target image. For example, a computer system may determine a pre-filtered image that corresponds to the scene viewed through the lens. The pre-filtered image may be determined based on the optical prescription to produce an image that may be viewed by the observer without prescription eyewear. The pre-filtered image may be blurry when viewed by itself, but in focus when viewed through a filter or light field generating element. Alternatively, the pre-filtered image may be determined to allow the observer to view the pre-filtered image while wearing prescription or non-prescription eyewear. At operation 170, a light field is produced after the pre-filtered image travels through a light field generating element, wherein the light field is operable to simulate a light field corresponding to a target image that simulates the electronic viewfinder. In one embodiment, the light field may be generated by a microlens array display. When viewed by a farsighted observer, the target image appears focused, allowing the observer to clearly see the scene while also viewing the target image that simulates the scene as viewed through the electronic viewfinder.

More illustrative information will now be set forth regarding various optional architectures and features with which the foregoing framework may or may not be implemented, per the desires of the observer. It should be strongly noted that the following information is set forth for illustrative purposes and should not be construed as limiting in any manner. Any of the following features may be optionally incorporated with or without the exclusion of other features described.

Embodiments of the present invention allow for attenuation-based light field displays that may allow lightweight displays. It should be appreciated that other embodiments are not limited to only attenuation-based light field displays, but also light-emitting-based light field displays. Using light field displays, comfortable viewing may be achieved by synthesizing a light field corresponding to a virtual display located within the accommodation range of an observer. For example, the light field display may be positioned at arm's length relative to a farsighted observer and the virtual display may be located further away from the farsighted observer.

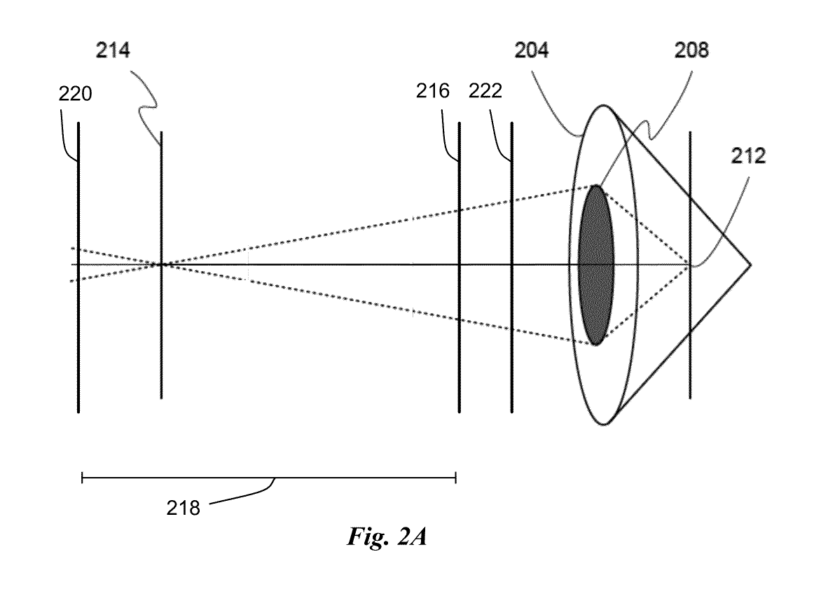

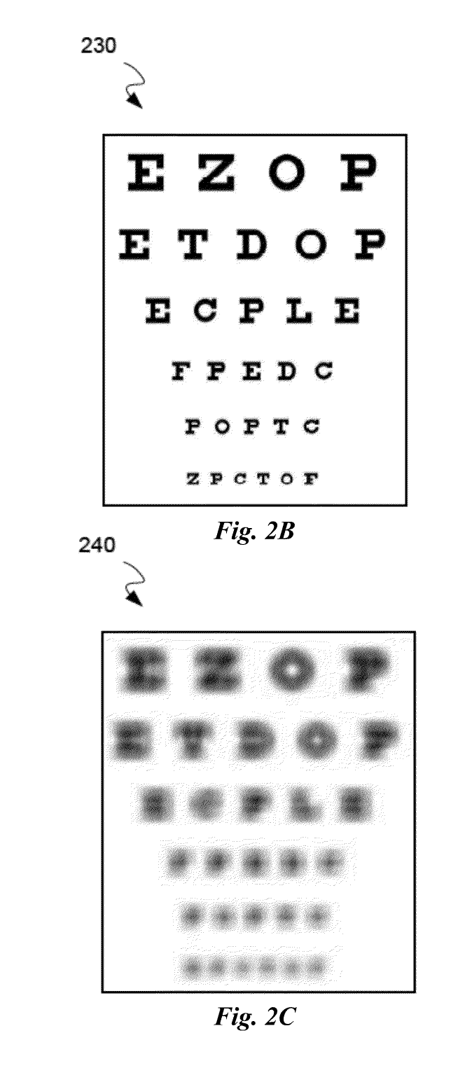

FIG. 2A illustrates an eye 204 of an observer and a corresponding accommodation range 218. The eye 204 includes a lens 208 that focuses viewed objects onto a retina surface 212 of the eye 204. The eye 204 may be capable of focusing on objects at various distances from the eye 204 and lens 208. For example, the eye 204 may be able to focus on an object that is located farther from the eye 204 than a near plane 216, e.g., at a plane of focus 214 beyond the near plane 216.

Accordingly, the eye 204 may have a natural or unaided accommodation range 218 that defines the minimum and maximum distance of an object at which the eye 204 is capable of focusing on. Note, for a farsighted observer, the accommodation range 218 is shifted further away from the eye 204 compared with a non-farsighted observer. In other words, the eye 204 may be incapable of focusing on an object that is located closer than a near plane 216 or that is closer to the eye 204 than the accommodation range 218. The near plane 216 corresponds to a minimum accommodation distance. For example, if the surface of an object is located at a near plane 222 that is located a distance from the eye 204 that is less than the distance to the near plane 216 (and outside of the accommodation range 218), the surface of the object will be out of focus to the observer. For a farsighted observer, an object at arm's length may be outside of the accommodation range 218 (i.e., too close to the eye 204). Examples of objects at arm's length that a farsighted observer may not be able to focus on include a display inside of a vehicle that is configured to display a scene exterior to the vehicle and an electronic viewfinder display of a handheld device.

Objects that are farther from the eye 204 than the near plane 216 are inside the accommodation range 218 and objects that are nearer to the eye 204 than the near plane 216 are outside the accommodation range 218. Objects that are nearer to the eye 204 than the near plane 216 are in a near range of a farsighted observer. Similarly, objects that are outside of the accommodation range 218 and further from the eye than a far plane 220 may appear out of focus to a nearsighted observer.

FIGS. 2B and 2C depict perceived images 230 and 240 at different viewing distances of an observer. For example, FIG. 2B shows an eye exam chart 230 as it would be perceived by a farsighted observer if it were located at the plane of focus 214 of the eye 204 in FIG. 2A. Or, the eye exam chart 230 may be located at a different plane of focus, as long as the eye exam chart 230 is within the accommodation range. As can be appreciated, the eye exam chart 230 is in focus, sharp, and/or recognizable.

Alternatively, FIG. 2C shows an eye exam chart 240 as it would be perceived by a farsighted observer if it were located nearer to the eye 204 than the plane of focus 214 in FIG. 2A. In other words, the eye exam chart 240 may be located outside the accommodation range at, for example, the near plane 222. As can be appreciated, the eye exam chart 240 is out of focus, blurry, and/or unrecognizable.

### Microlens Array Displays

Conventional displays, such as liquid crystal displays (LCDs) and organic light-emitting diodes (OLEDs), are designed to emit light isotropically (uniformly) in all directions. In contrast, light field displays support the control of individual rays of light. For example, the radiance of a ray of light may be modulated as a function of position across the display, as well as the direction in which the ray of light leaves the display.

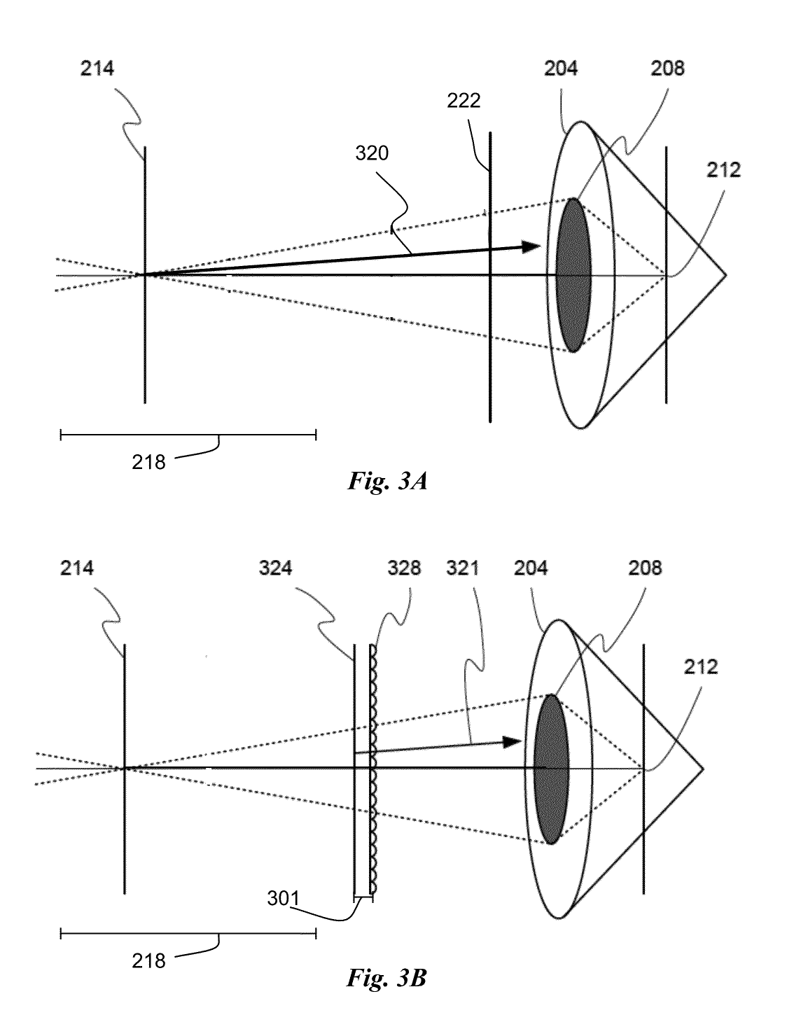

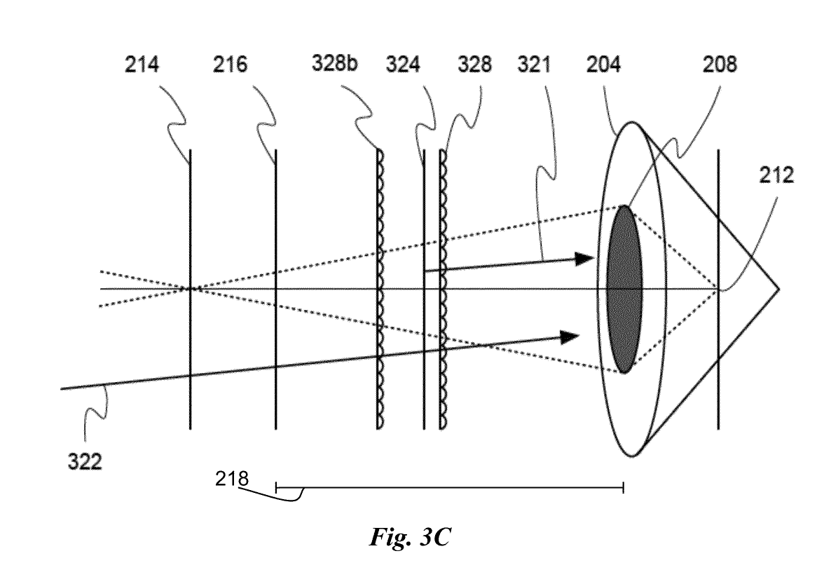

FIG. 3A illustrates a ray of light 320 originating from a plane of focus 214, according to embodiments of the present invention. FIG. 3A includes the same eye 204, lens 208, retina plane 212, plane of focus 214, and accommodation range 218 of FIG. 2A. FIG. 3A also includes a ray of light 320 that originates from the surface of an object that is located at the plane of focus 214. The origination point, angle, intensity, and color of the ray of light 320 and other rays of light viewable by the observer provide a view of an in-focus object to the observer.

FIG. 3B illustrates a side view of a microlens array display 301 that is located outside the accommodation range of a farsighted observer, according to embodiments of the present invention. FIG. 3B includes the same elements as FIG. 3A, with the addition of a display 324 and a microlens array 328. While FIG. 3A shows the microlens array 328 between the display 324 and the eye 204, embodiments allow for the display 324 between the microlens array 328 and the eye 204, assuming that the display 324 is transparent.

The display 324 may be, but is not limited to being, an LCD or OLED). The microlens array 328 may be a collection of multiple microlenses. The microlens array 328 or each individual microlens may be formed by multiple surfaces to minimize optical aberrations. The display 324 may provide an image according to information represented by a pre-filtered image determined at operations 120 and 160 of FIGS. 1A and 1B, respectively, where the display 324 emits rays of light isotropically. However, when the rays of light reach the microlens array 328, the microlens array 328 may allow certain rays of light to refract toward or pass through toward the eye 204 while refracting other rays of light away from the eye 204, thereby producing a target image that appears to be different compared with the image provided by the display 324. The information that is used to configure the microlens array 328 may be represented by the pre-filtered image.

Accordingly, the microlens array 328 may allow the light from select pixels of the display 324 to refract toward or pass through toward the eye 204, while other rays of light pass through but refract away from the eye 204. As a result, the microlens array 328 may allow a ray of light 321 to pass through, simulating the ray of light 320 of FIG. 3A. For example, the ray of light 321 may have the same angle, intensity, and color of the ray of light 320. Importantly, the ray of light 321 does not have the same origination point as the ray of light 320 since it originates from display 324 and not the plane of focus 214, but from the perspective of the eye 204, the ray of light 321 is equivalent to the ray of light 320. Therefore, regardless of the origination point of the ray of light 321, the object represented by the ray of light 321 appears to be located at the plane of focus 214, when no object in fact exists at the plane of focus 214.

Importantly, the display 324 and the microlens array 328 are located outside the accommodation range of the eye 204 for a farsighted observer. In other words, the display 324 is located at a distance closer than and outside of the accommodation range 218. However, because the microlens array 328 creates a light field (as discussed below) that mimics or simulates the rays of light emitted by an object outside the accommodation range 218 that can be focused on by the farsighted observer, the image shown by display 324 and transmitted through the microlens array 328 may be in focus when viewed by the farsighted observer.

FIG. 3C illustrates a side view of a multiple microlens arrays 328 and 328b, according to embodiments of the present invention. FIG. 3C includes similar elements as FIG. 3B. FIG. 3C also includes a microlens array 328b that may be disposed closer to the eye 204 and outside of the accommodation range 218 and the display 324. The microlens array 328b, may for example, comprise concave lenses rather than convex lenses. The combination of the microlens arrays 328 and 328b may allow a ray of light 322 originating from beyond the display 324 and microlens arrays 328 and 328b (e.g., from the surrounding environment) to pass through a microlens system. The microlens arrays 328 and 328b may comprise multiple microlenses, in addition to other elements including masks, prisms, or birefringent materials. Further, it should be appreciated that the microlens array 328 may instead be or be replaced with an array of spatial light modulators or a parallax barrier.

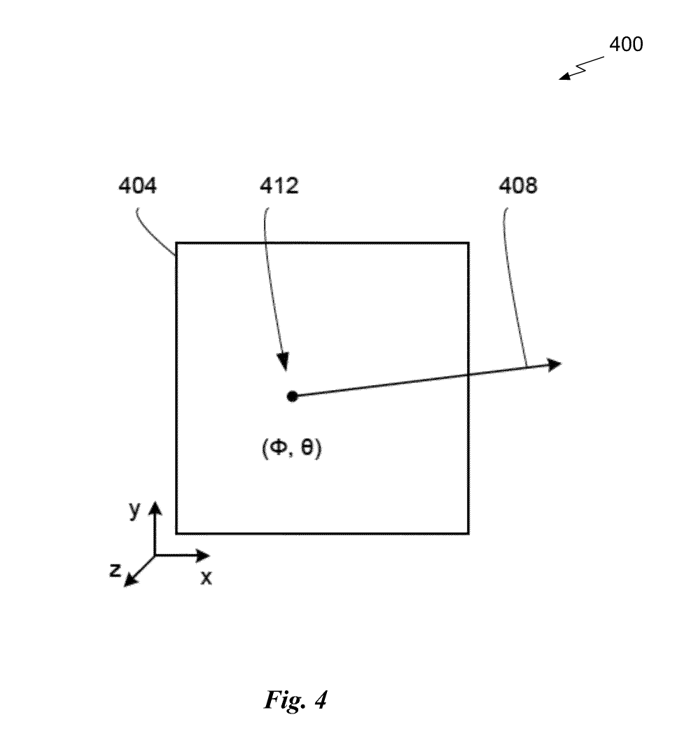

FIG. 4 illustrates a ray of light 408 that is part of a light field, according to embodiments of the present invention. The light field may define or describe the appearance of a surface 404, multiple superimposed surfaces, or a general 3D scene. For a general virtual 3D scene, the set of (virtual) rays that may impinge on the microlens array 328 must be recreated by the display device. As a result, the surface 404 would correspond to the plane of the display 324 and each ray 408 would correspond to a ray 320 intersecting the plane of the display 324, resulting in the creation of an emitted ray 321 from the light field display.

More specifically, the light field may include information for rays of light for every point and light ray radiation angle on the surface 404, which may describe the appearance of the surface 404 from different distances and angles. For example, for every point on surface 404, and for every radiation angle of a ray of light, information such as intensity and color of the ray of light may define a light field that describes the appearance of the surface 404. Such information for each point and radiation angle constitute the light field.

In FIG. 4, the ray of light 408 my radiate from an origination point 412 of the surface 404, which may be described by an ‘x’ coordinate and a ‘y’ coordinate. Further, the ray of light 408 may radiate into 3-dimensional space with an x (horizontal), y (vertical), and z (depth into and out of the page) component. Such an angle may be described by the angles Φ and θ. Therefore, each (x, y, Φ, θ) coordinate may describe a ray of light, e.g., the ray of light 408 shown. Each (x, y, Φ, θ) coordinate may correspond to a ray of light intensity and color, which together form the light field. For video applications, the light field intensity and color may vary over time (t) as well. Similarly, to simulate a side or rear view mirror, the light field intensity and color may vary over time.

Once the light field is known for the surface 404, the appearance of the surface 404, with the absence of the actual surface 404, may be created or simulated to an observer. The origination points of rays of light simulating the surface 404 may be different from the actual origination points of the actual rays of light from the surface 404, but from the perspective of an observer, the surface 404 may appear to exist as if the observer were actually viewing it.

Returning to FIG. 3B, the display 324 in conjunction with the microlens array 328 may produce a light field that may mimic or simulate an object at the plane of focus 214. As discussed above, from the perspective of the eye 204, the ray of light 321 may be equivalent to the ray of light 320 of FIG. 3A. Therefore, an object that is simulated to be located at the viewing plane 214 by the display 324 and the microlens array 328 may appear to be in focus to the eye 204 because the equivalent light field for a real object is simulated. Further, because the equivalent light field for a real object is simulated, the simulated object will appear to be 3-dimensional. In other words, because the direction of light is simulated for each pixel representing the object, each eye of the user may perceive the object as having varying depth for each pixel.

In some cases, limitations of a light field display's resolution may cause a produced ray of light to only approximately replicate a ray of light. For example, with respect to FIGS. 3A and 3B, the ray of light 321 may have a slightly different color, intensity, position, or angle than the ray of light 320. Given the quality of the pre-filtering algorithm, the capabilities of the light field display, and the ability of the human visual system to perceive differences, the set of rays 321 emitted by the display may approximate or fully replicate the appearance of a virtual object, such as the surface 404. In cases where the appearance is approximated, rays may not need to be exactly replicated for appropriate or satisfactory image recognition. Furthermore, rays may be modified according to a corrective prescription corresponding to the observer.

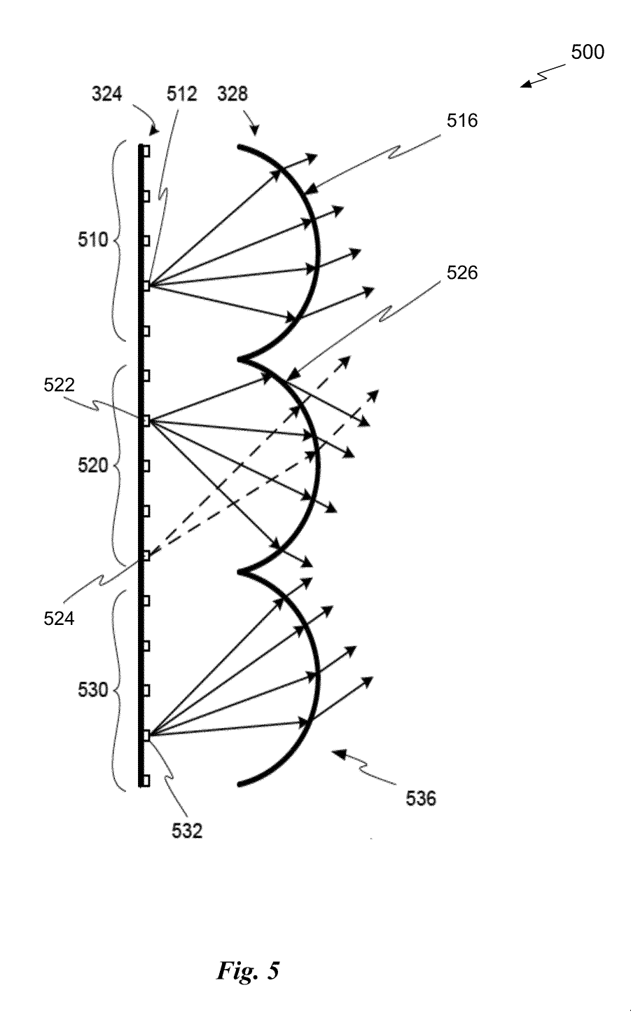

FIG. 5 illustrates a magnified side view of the display 324 and microlens array 328 of FIG. 3B, according to embodiments of the present invention. The display 324 may include multiple pixels, for example, pixels 512, 522, 524, and 532. The pixels may be associated into pixel groups. For example, the pixel group 510 includes the pixel 512, the pixel group 520 includes the pixels 522 and 524, and the pixel group 530 includes the pixel 532. Each pixel group may correspond with a microlens of the microlens array 328. For example, the pixel groups 510, 520, and 530 may be located adjacent to microlenses 516, 526, and 536, respectively.

As discussed above, the pixels of the display 324 may emit light isotropically (uniformly) in all directions. However, the microlens array 328 may align the light emitted by each pixel to travel substantially anisotropically (non-uniformly) in one direction or in a narrow range of directions (e.g., an outgoing beam may spread or converge/focus by a small angle). In fact, it may be desirable in some cases, such as to align the light based on a corrective prescription corresponding to the observer. For example, the pixel 532 may emit rays of light in all directions, but after the rays of light reach the microlens 536, the rays of light may be all caused to travel in one direction. As shown, the rays of light emitted by pixel 532 may all travel in parallel toward the eye 204 after they have passed through the microlens 536. As a result, the display 324 and microlens array 328 are operable to create a light field using rays of light to simulate the appearance of an object. The information associated with the light field is defined by the pre-filtered image.

The direction that the rays of light travel may depend on the location of the emitting pixel relative to a microlens. For example, while the rays emitted by the pixel 532 may travel toward the upper right direction, rays emitted by the pixel 522 may travel toward the lower right direction because pixel 522 is located higher than pixel 532 relative to their corresponding microlenses. Accordingly, the rays of light for each pixel in a pixel group may not necessarily travel toward the eye. For example, the dotted rays of light emitted by pixel 524 may not travel toward the eye 204 when the eye 204 is positioned looking towards the microlens array 328 and the display 324.

It should be appreciated that the display 324 may include rows and columns of pixels such that a pixel that is located into or out of the page may generate rays of light that may travel into or out of the page. Accordingly, such light may be caused to travel in one direction into or out of the page after passing through a microlens.

It should also be appreciated that the display 324 may display an image that is recognizable or in focus only when viewed through the microlens array 328. For example, if the image produced by the display 324 is viewed without the microlens array 328, it may not be equivalent to the image perceived by the eye 204 with the aid of the microlens array 328 even if viewed at a distance within the accommodation range 218. The display 324 may display a pre-filtered image, corresponding to a target image to be ultimately projected, that is unrecognizable when viewed without the microlens array 328.

The pre-filtered image may represent a light field including various information for each pixel, such as radiation angle of a ray of light and intensity and color of the ray of light. When the display 324 is a conventional light-emitting display, the display 324 may be configurable to display the color and intensity information represented by the pre-filtered image. However, the display 324 may not be configurable to adjust angles of rays of light defined by the pre-filtered image, i.e., the display 324 projects emitted light isotropically, whereas the microlens array 328 can be configured based on angle information to produce the light field represented by the pre-filtered image. Therefore, when the pre-filtered image is viewed with the microlens array 328, the target image may be produced and recognizable.

A computer system or graphics processing system may generate the pre-filtered image corresponding to the target image. Furthermore, the pre-filtered image may be reflected and/or generated according to a corrective prescription. It should be appreciated that microlens arrays and/or displays may occupy only a portion of the view of an observer. For example, a microlens display may be used to display a portion of an instrument panel (e.g., gauge, speedometer, clock, etc.) in a vehicle or a target image simulating a rear or side view mirror of a vehicle.

It should be appreciated that embodiments of the invention provide for combining layers of light field displays, parallax barrier displays, and/or optical deconvolution displays. Light field displays and optical deconvolution displays may present different performance trade-offs. Light field displays may require high-resolution underlying displays to achieve sharp imagery, but otherwise preserve image contrast. In contrast, optical deconvolution displays may preserve image resolution, but reduce contrast. The light field displays and optical deconvolution displays may be combined in order to benefit from the performance of each display and to support a continuous trade-off between resolution and contrast. For example, embodiments of the invention support performing optical deconvolution in the light field domain, rather than applied independently to each display layer. Light field displays, parallax barrier displays, and/or optical deconvolution displays may be combined because such displays may implement semi-transparent displays. For example, such displays may implement a combination of light-attenuating (e.g., LCD) or light-emitting (e.g., OLED) displays.

It should be appreciated that embodiments of the invention allow for the use of multiple displays tiled together to form one effective display. For example, the display 324 may comprise multiple sub-displays. Sub-displays may be tiled, e.g. side by side, to synthesize a larger display. Unlike multiple monitor workstations, any gaps between displays may not introduce artifacts because the pre-filtered images may be modified to display on each tile to accommodate for the gaps between them.

In various embodiments, light from the surrounding environment may function as a backlight, with the display layers attenuating the incident light field. In some embodiments, at least one display layer may contain light-emitting elements (e.g., an OLED panel). In embodiments of the invention, a combination of light-attenuating and light-emitting layers can be employed. It should be appreciated that more than one layer may emit light.

In one or more embodiments, each display layer may include either a light-attenuating display or a light-emitting display, or a combination of both (each pixel may attenuate and/or emit rays of light). Further embodiments may include multi-layer devices, for example, OLED and LCD, LCD and LCD, or and so on.

Further embodiments of the invention may include holographic display elements. For example, as the resolution increases, the pitch may become small enough such that diffractive effects may be accounted for. Image formation models and optimization methods may be employed to account for diffraction, encompassing the use of computer-generated holograms for displays in a manner akin to light field displays. Embodiments of the present invention provide for applying optical deconvolution to holographic systems, thereby eliminating the contrast loss observed with incoherent displays.

Embodiments of the present invention provide for adjusting produced images to account for aberrations or defects of an observer's eyes. The aberrations may include, for example, myopia, hyperopia, astigmatism, and/or presbyopia. For example, a light field display, parallax display, or optical deconvolution display may produce images to counteract the effects of the observer's aberrations based on the observer's optical prescription. As a result, an observer may be able to view images in focus without corrective eyewear like eyeglasses or contact lenses. It should be appreciated that embodiments of the invention may also automatically calibrate the vision correction adjustments with the use of a feedback system that may determine the defects of an eye.

Embodiments of the invention may also adjust the provided image based on information from an eye-track adjustment system that may determine the direction of gaze and/or the distance of the eye from the display(s). Accordingly, the display(s) may adjust the image displayed to optimize the recognizability of the image for different directions of gaze, distances of the eye from the display, and/or aberrations of the eye.

Embodiments of the invention may also adjust the provided image based on information from one or more sensors. For example, embodiments may include an environmental motion-tracking component that may include a camera. The environmental motion-tracking component may track movement or changes in the surrounding environment (e.g., movement of objects or changes in lighting). In a further example, the movement of an observer's body may be tracked and related information may be provided. As a result, embodiments of the invention may adjust the provided image based on the environment of an observer, motions of an observer, or movement of an observer.

In another example, embodiments of the invention may include an internal motion-tracking component that may include a gyroscopic sensor, accelerometer sensor, an electronic compass sensor, or the like. The internal motion-tracking component may track movement of the observer and provide information associated with the tracked movement. As a result, embodiments of the invention may adjust the provided image based on the motion. In other examples, sensors may determine and provide the location of an observer (e.g., GPS), a head position or orientation of an observer, the velocity and acceleration of the viewer's head position and orientation, environmental humidity, environmental temperature, altitude, and so on.

Information related to the sensor determinations may be expressed in either a relative or absolute frame of reference. For example, GPS may have an absolute frame of reference to the Earth's longitude and latitude. Alternatively, inertial sensors may have a relative frame of reference while measuring velocity and acceleration relative to an initial state (e.g., an image capture device is currently moving at 2 mm per second vs. the image capture device is at a given latitude/longitude).

FIG. 6A depicts a flowchart 600 of an exemplary technique for processing a scene for display using a light field display, according to an embodiment of the present invention. At operation 610, a scene corresponding to an exterior viewpoint relative to an observer is received. For example, an observer may be positioned in a vehicle such as an automobile or an airplane and the exterior viewpoint may be a scene as viewed from the exterior of the vehicle. The scene may be captured via a camera. At operation 615, vision correction information is received.

An example of vision correction is an optical prescription specific to the observer that correct for aberrations of the eye.

At operation 616, per-pixel depth information is received for the scene. The per-pixel depth information may be used to display a target image that appears to be 3D with objects at different depths. At operation 618, eye-tracking information, e.g., head and/or eye position information, gaze information, etc., is received. An eye-track adjustment system that may determine the direction of gaze and/or the distance of the eye from the display(s) may be utilized to provide the eye-tracking information. Accordingly, the light field represented by the pre-filtered image may be adjusted to optimize the recognizability of the target image for different directions of gaze, distances of the eye from the light field display, and/or aberrations of the eye.

At operation 620, a pre-filtered image to be displayed is determined, where the pre-filtered image represents a light field that corresponds to a target image. For example, a computer system may determine a pre-filtered image that simulates a reflection of the scene. The pre-filtered image may be determined based one or more of the vision correction information, per-pixel depth information, and eye-tracking information, to produce an image that simulates a reflection of the scene and that may be viewed by the observer. The pre-filtered image may be blurry when viewed by itself, but in focus when viewed through a filter or light field generating element.

At operation 630, a light field is produced after the pre-filtered image travels through a light field generating element that is operable to produce a light field corresponding to a target image that simulates a mirror. In one embodiment, the light field may be generated by a microlens array display. When viewed by an observer, the target image that is displayed at a position that is the closer to and outside of the accommodation range 218 from the observer appears focused, allowing the observer to clearly see through the windshield while also viewing the target image that simulates a rear-view, side-view, or other mirror reflecting an exterior viewpoint relative to the vehicle. Employing a light field to display the pre-filtered image that is generated based on one or more of the vision correction information, per-pixel depth information, and eye-tracking information, causes the target image to appear in focus to an observer without requiring corrective eyewear.

In addition, a light field display may be used to display a portion of an instrument panel (e.g., gauge, speedometer, clock, etc.) in a vehicle based on one or more of the vision correction information, per-pixel depth information, and eye-tracking information. When viewed by an observer, the target image of a portion of the instrument panel that is displayed at a position that is the closer to and outside of the accommodation range 218 from the observer appears focused, allowing the observer to clearly see through the windshield while also viewing the target image.

FIG. 6B depicts another flowchart 640 of an exemplary process of processing a scene for display using a light field display, according to an embodiment of the present invention. At operation 650, a scene corresponding to a viewpoint through an electronic viewfinder is received. For example, an observer may be operating an image capture device, e.g., camera, held at arm's length to capture a scene viewed through a lens. At operation 655, vision correction information is received. An example of vision correction is an optical prescription specific to the observer that correct for aberrations of the eye.

At operation 656, per-pixel depth information is received for the scene. The per-pixel depth information may be used to display a target image that appears to be 3D with objects at different depths. At operation 658, eye-tracking information, e.g., head and/or eye position information, gaze information, etc., is received. An eye-track adjustment system that may determine the direction of gaze and/or the distance of the eye from the display(s) may be utilized to provide the eye-tracking information. Accordingly, a light field generating element may be adjusted to optimize the recognizability of the target image for different directions of gaze, distances of the eye from the light field generating element, and/or aberrations of the eye.

At operation 660, a pre-filtered image to be displayed is determined, where the pre-filtered image simulates the scene and represents a light field that corresponds to a target image. For example, a computer system may determine a pre-filtered image that corresponds to the scene viewed through the lens. The pre-filtered image may be determined based on the optical prescription to produce a target image that may be viewed by the observer without prescription eyewear. The pre-filtered image may be blurry when displayed by a light-emitting device, but may appear in focus when viewed through a filter or light field generating element. Alternatively, the pre-filtered image may be determined to allow the observer to view the pre-filtered image while wearing prescription or non-prescription eyewear.

At operation 670, a light field is produced after the pre-filtered image is transmitted through a light field generating element, wherein the light field is operable to simulate a light field corresponding to a target image that simulates the electronic viewfinder. In one embodiment, the light field represented by the pre-filtered image may be generated by a microlens array display. Employing a light field generating element to display the pre-filtered image that is generated based on one or more of the vision correction information, per-pixel depth information, and eye-tracking information, causes the target image to appear in focus to an observer without requiring corrective eyewear, allowing the observer to clearly see the scene while also viewing the target image that simulates the scene as viewed through the electronic viewfinder.

FIG. 7 is a block diagram of an example of a computing system 710 capable of implementing embodiments of the present disclosure. Computing system 710 broadly represents any single or multi-processor computing device or system capable of executing computer-readable instructions. Examples of computing system 710 include, without limitation, workstations, laptops, client-side terminals, servers, distributed computing systems, embedded devices, automotive computing devices, handheld devices (e.g., cellular phone, tablet computer, digital camera, etc.), worn devices (e.g. head-mounted or waist-worn devices), or any other computing system or device. In its most basic configuration, computing system 710 may include at least one processor 714 and a system memory 716.

Processor 714 generally represents any type or form of processing unit capable of processing data or interpreting and executing instructions. In certain embodiments, processor 714 may receive instructions from a software application or module. These instructions may cause processor 714 to perform the functions of one or more of the example embodiments described and/or illustrated herein.

System memory 716 generally represents any type or form of volatile or non-volatile storage device or medium capable of storing data and/or other computer-readable instructions. Examples of system memory 716 include, without limitation, RAM, ROM, flash memory, or any other suitable memory device. Although not required, in certain embodiments computing system 710 may include both a volatile memory unit (such as, for example, system memory 716) and a non-volatile storage device (such as, for example, primary storage device 732).

Computing system 710 may also include one or more components or elements in addition to processor 714 and system memory 716. For example, in the embodiment of FIG. 7, computing system 710 includes a memory controller 718, an input/output (I/O) controller 720, and a communication interface 722, each of which may be interconnected via a communication infrastructure 712. Communication infrastructure 712 generally represents any type or form of infrastructure capable of facilitating communication between one or more components of a computing device. Examples of communication infrastructure 712 include, without limitation, a communication bus (such as an Industry Standard Architecture (ISA), Peripheral Component Interconnect (PCI), PCI Express (PCIe), or similar bus) and a network.

Memory controller 718 generally represents any type or form of device capable of handling memory or data or controlling communication between one or more components of computing system 710. For example, memory controller 718 may control communication between processor 714, system memory 716, and I/O controller 720 via communication infrastructure 712.

I/O controller 720 generally represents any type or form of module capable of coordinating and/or controlling the input and output functions of a computing device. For example, I/O controller 720 may control or facilitate transfer of data between one or more elements of computing system 710, such as processor 714, system memory 716, communication interface 722, display adapter 726, input interface 730, and storage interface 734.

Communication interface 722 broadly represents any type or form of communication device or adapter capable of facilitating communication between example computing system 710 and one or more additional devices. For example, communication interface 722 may facilitate communication between computing system 710 and a private or public network including additional computing systems. Examples of communication interface 722 include, without limitation, a wired network interface (such as a network interface card), a wireless network interface (such as a wireless network interface card), a modem, and any other suitable interface. In one embodiment, communication interface 722 provides a direct connection to a remote server via a direct link to a network, such as the Internet. Communication interface 722 may also indirectly provide such a connection through any other suitable connection.

Communication interface 722 may also represent a host adapter configured to facilitate communication between computing system 710 and one or more additional network or storage devices via an external bus or communications channel. Examples of host adapters include, without limitation, Small Computer System Interface (SCSI) host adapters, Universal Serial Bus (USB) host adapters, IEEE (Institute of Electrical and Electronics Engineers) 1394 host adapters, Serial Advanced Technology Attachment (SATA) and External SATA (eSATA) host adapters, Advanced Technology Attachment (ATA) and Parallel ATA (PATA) host adapters. Fibre Channel interface adapters, Ethernet adapters, or the like. Communication interface 722 may also allow computing system 710 to engage in distributed or remote computing. For example, communication interface 722 may receive instructions from a remote device or send instructions to a remote device for execution.

As illustrated in FIG. 7, computing system 710 may also include at least one display device 724 coupled to communication infrastructure 712 via a display adapter 726. Display device 724 generally represents any type or form of device capable of visually displaying information forwarded by display adapter 726. Similarly, display adapter 726 generally represents any type or form of device configured to forward graphics, text, and other data for display on display device 724.

As illustrated in FIG. 7, computing system 710 may also include at least one input device 728 coupled to communication infrastructure 712 via an input interface 730. Input device 728 generally represents any type or form of input device capable of providing input, either computer- or human-generated, to computing system 710. Examples of input device 728 include, without limitation, a keyboard, a pointing device, a speech recognition device, an eye-track adjustment system, environmental motion-tracking sensor, an internal motion-tracking sensor, a gyroscopic sensor, accelerometer sensor, an electronic compass sensor, a charge-coupled device (CCD) image sensor, a complementary metal-oxide-semiconductor (CMOS) image sensor, or any other input device.

As illustrated in FIG. 7, computing system 710 may also include a primary storage device 732 and a backup storage device 733 coupled to communication infrastructure 712 via a storage interface 734. Storage devices 732 and 733 generally represent any type or form of storage device or medium capable of storing data and/or other computer-readable instructions. For example, storage devices 732 and 733 may be a magnetic disk drive (e.g., a so-called hard drive), a floppy disk drive, a magnetic tape drive, an optical disk drive, a flash drive, or the like. Storage interface 734 generally represents any type or form of interface or device for transferring data between storage devices 732 and 733 and other components of computing system 710.

In one example, databases 740 may be stored in primary storage device 732. Databases 740 may represent portions of a single database or computing device or it may represent multiple databases or computing devices. For example, databases 740 may represent (be stored on) a portion of computing system 710 and/or portions of example network architecture 200 in FIG. 2 (below). Alternatively, databases 740 may represent (be stored on) one or more physically separate devices capable of being accessed by a computing device, such as computing system 710 and/or portions of network architecture 200.

Continuing with reference to FIG. 7, storage devices 732 and 733 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 732 and 733 may also include other similar structures or devices for allowing computer software, data, or other computer-readable instructions to be loaded into computing system 710. For example, storage devices 732 and 733 may be configured to read and write software, data, or other computer-readable information. Storage devices 732 and 733 may also be a part of computing system 710 or may be separate devices accessed through other interface systems.

Many other devices or subsystems may be connected to computing system 710. Conversely, all of the components and devices illustrated in FIG. 7 need not be present to practice the embodiments described herein. The devices and subsystems referenced above may also be interconnected in different ways from that shown in FIG. 7. Computing system 710 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into computing system 710. All or a portion of the computer program stored on the computer-readable medium may then be stored in system memory 716 and/or various portions of storage devices 732 and 733. When executed by processor 714, a computer program loaded into computing system 710 may cause processor 714 to perform and/or be a means for performing the functions of the example embodiments described and/or illustrated herein. Additionally or alternatively, the example embodiments described and/or illustrated herein may be implemented in firmware and/or hardware.

For example, a computer program for determining a pre-filtered image based on a target image may be stored on the computer-readable medium and then stored in system memory 716 and/or various portions of storage devices 732 and 733. When executed by the processor 714, the computer program may cause the processor 714 to perform and/or be a means for performing the functions required for carrying out the determination of a pre-filtered image discussed above.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method, comprising:
receiving a scene representing an exterior viewpoint relative to an observer positioned in a vehicle;
determining a pre-filtered image that simulates a reflection of the scene, wherein the pre-filtered image represents a light field and corresponds to a target image; and
displaying the pre-filtered image as the light field to produce the target image.

2. The method of claim 1, wherein the displaying comprises transmitting the pre-filtered image through a microlens array to produce the light field.

3. The method of claim 2, wherein the microlens array is located at a distance from the observer that is closer than and outside of an accommodation range associated with the observer.

4. The method of claim 2, wherein the microlens array comprises a plurality of microlenses, and the microlens array is operable to produce the light field by altering light emitted by a light-emitting display to simulate a reflection of the scene that appears in focus to the observer.

5. The method of claim 2, wherein the microlens array is operable to project anisotropic light by altering isotropic light produced by a display to simulate a reflection of the scene that appears in focus to the observer.

6. The method of claim 1, further comprising receiving visual correction information associated with the observer, wherein the pre-filtered image is determined based on the visual correction information so that the target image appears in focus to the observer.

7. The method of claim 1, further comprising receiving eye-tracking information associated with the observer, wherein the pre-filtered image is determined based on the eye-tracking information so that the target image appears in focus to the observer.

8. The method of claim 1, further comprising receiving per-pixel depth information corresponding to the scene, wherein the pre-filtered image is determined based on the per-pixel depth information.

9. The method of claim 1, wherein the target image simulates a side-view mirror.

10. The method of claim 1, wherein the target image simulates a rear-view mirror.

11. The method of claim 1, wherein determining the pre-filtered image further comprises applying a non-linear distortion.

12. A method, comprising:
determining a pre-filtered image that simulates a portion of an instrument panel, wherein the pre-filtered image represents a light field and corresponds to a target image; and
displaying the pre-filtered image as the light field to produce the target image.

13. The method of claim 12, wherein the displaying comprises transmitting the pre-filtered image through a microlens array to produce the light field.

14. The method of claim 13, wherein the microlens array is located at a distance from an observer that is closer than and outside of an accommodation range associated with the observer.

15. An apparatus, comprising:
a processor that is coupled to a memory and configured to:
receive a scene representing an exterior viewpoint relative to an observer positioned in a vehicle; and
determine a pre-filtered image that simulates a reflection of the scene, wherein the pre-filtered image represents a light field and corresponds to a target image; and
a display device that is coupled to the processor and configured to display the pre-filtered image as the light field to produce the target image.

16. The apparatus of claim 15, wherein the display device comprises a microlens array through which the pre-filtered image is transmitted to produce the light field.

17. The apparatus of claim 16, wherein the microlens array is located at a distance from the observer that is closer to and outside of an accommodation range associated with the observer.

18. The apparatus of claim 16, wherein the microlens array comprises a plurality of microlenses, and the microlens array is operable to produce the light field by altering light emitted by a light-emitting display to simulate a reflection of the scene that appears in focus to the observer.

19. The apparatus of claim 16, further comprising receiving visual correction information associated with the observer, wherein the pre-filtered image is determined based on the visual correction information so that the target image appears in focus to the observer.

20. The apparatus of claim 16, further comprising receiving eye-tracking information associated with the observer, wherein the pre-filtered image is determined based on the eye-tracking information so that the target image appears in focus to the observer.
